(19) United States
(12) Patent Application Publication
(10) Pub. No.: US 2025/0109335 A1
(43) Pub. Date: Apr. 3, 2025

(54) HEAT-CONDUCTING FLAME-RETARDANT MATERIAL

(71) Applicant: G2F Tech Co., Ltd., Taipei City (TW)

(72) Inventor: Jie-Qi LU, Taipei City (TW)

(21) Appl. No.: 18/644,403

(22) Filed: Apr. 24, 2024

(30) Foreign Application Priority Data
Sep. 28, 2023 (TW) 112137533

(51) Int. Cl. C09K 21/02; H01M 10/653; H01M 50/383

(52) U.S. Cl. CPC C09K 21/02; H01M 10/653; H01M 50/383

(57) ABSTRACT

The present invention provides a heat-conducting flame-retardant material, wherein the heat-conducting flame-retardant material is a liquid state, colloidal state, or a semisolid state, and comprises: silicon dioxide, which accounts for 10-85% of the entire weight; a reactant, which has crosslinking properties and foaming reactivity, and is mixed with the silicon dioxide; and a catalyst, which is a temperature active or photoactive catalyst, and when mixed with the reactant triggers a foaming reaction of the reactant. Before a foaming reaction of the reactant occurs, the heat-conducting flame-retardant material has heat conductivity properties, and is provided with flame retardant characteristics after a foaming reaction of the reactant occurs.

### BACKGROUND OF THE INVENTION

### (a) Field of the Invention

The present invention relates to a sealing material that has application in providing electronic components with anti-explosion and flame retardant properties; in particular the present invention has application in a covering for battery cores, which causes a foaming reaction to occur that blocks heat transfer from a battery core, thereby preventing overheating, exploding, and extended combustion.

### (b) Description of the Prior Art

Heat-conducting flame-retardant material is provided with the characteristics to prevent heat transfer and block the spread of fire. This material is usually used in areas such as buildings, industrial facilities, and transportation to improve fire safety and fireproof performance. Regarding preparation methods and applied research of composite materials in the prior art, China Patent No. CN116496628A discloses preparation raw materials for an insulating composite material, comprising a substrate and a resin composition, wherein the resin composition includes the following components: 100 parts by weight of hydroxy terminated polysiloxane, 5˜20 parts by weight of vinyl polysiloxane, 20˜50 parts by weight of hydrogenated polysiloxane, 0.1˜5 parts by weight of sulfonyl hydrazide foaming agent, 0.1˜1 parts by weight of a drying agent, 1-20 parts by weight of a metal hydride, and 5˜50 parts by weight of silicon dioxide aerogel. A crosslinking network structure of uniform porosity is formed after hardening and foaming the resin composition through component design and compounding of the resin composition, endowing the heat insulating composite material with excellent flame retardancy, low thermal conductivity, tolerance to high temperatures, and heat insulation properties, which fully satisfy the requirements for building materials, electric appliances, chemical equipment, power storage equipment, and mechanical equipment, or application in the oil production industry.

As for research in the prior art regarding curable silicone compositions, Taiwan Patent No. TW202311437A discloses a cured material with high thixotropic properties, and exhibits excellent refractive index characteristics and transparency, which uses a curable silicone composition containing the following components: (A) an alkenyl-containing organopolysiloxane with at least two alkenyl groups per molecule; (B) an organohydrogen polysiloxane with at least two silicon atom-bonded hydrogen atoms per molecule; (C) more than 3% by mass of silicon dioxide-titanium oxide composite particles relative to the total mass of the composition; and (D) a catalyst for curing.

A foaming agent is a type of chemical substance or additive agent used in manufacturing foam or foam material, which has wide use in different industries and applications, and is usually used to change the density, structure and characteristic properties of a material. As for research in the prior art regarding preparation methods for aerogel-modified, heat-resistant, rigid polyurethane foam, China Patent No. CN109232850A discloses dispersing a composite aerogel heat-resistant flame retardant into polyurethane to form a modified polyurethane foam material. The composite heat-resistant flame retardant is a composite heat-resistant flame retardant formed by modifying aerogel powder with a phosphate ester heat-resistant flame retardant. The modified aerogel composite heat-resistant flame retardant is added to rigid polyurethane foam (RPUF) and uniformly dispersed therein, whereby, after heating, curing and aging, a heat-resistant rigid polyurethane foam is obtained with flame retardancy and low thermal conductivity properties. The modified RPUF has a temperature resistance up to 153° C., thermal conductivity is lower than 0.027 W/m·K, limiting oxygen index is greater than or equal to 32%, and compression strength is 0.39˜0.40 MPa.

As for research in the prior art regarding preparation methods for high performance fire retardant phenolic foams, China Patent No. CN111732814B discloses a high performance fire retardant phenolic foam prepared from an inorganic flame retardant material, phenolic resin, polyethylene glycol, an emulsifier, and a foaming agent, which are mixed together and a curing agent added. The inorganic flame retardant material is obtained by mixing aluminum hydroxide, cerium dioxide, and silicon dioxide in the proportion 10˜25:5˜10:8˜25, respectively. Mixing of a specific ratio of organic and inorganic acids (the ratio of organic acids to inorganic acids being 1:3) acts as a curing agent. The prepared phenolic foam obtained has a fire spread index of 0, and the smoke index is reduced to 35; moreover, the measured thermal conductivity is ≤0.023 W/m·k. The high performance fire retardant phenolic foam has good heat insulation properties, meeting the higher requirements for effective flameproof and fire retardant standards.

### SUMMARY OF THE INVENTION

The present invention provides a heat-conducting flame-retardant material, wherein the heat-conducting flame-retardant material is a liquid state, colloidal state, or a semisolid state, and comprises: silicon dioxide, which accounts for 10˜85% of the entire weight; a reactant, which has crosslinking properties and foaming reactivity, and is mixed with the silicon dioxide; and a catalyst; which is a temperature active or photoactive catalyst, and when mixed with the reactant triggers a foaming reaction of the reactant. Before a foaming reaction of the reactant occurs, the heat-conducting flame-retardant material has heat conductivity, and is provided with flame retardant characteristics after a foaming reaction of the reactant occurs. The average particle diameter of the silicon dioxide is 5 nm˜10 μm, and the reactant starts a foaming reaction in an ambient temperature greater than 130° C. In an ambient temperature greater than 160° C., the reactant starts a foaming reaction that is completed in 30 seconds to 5 minutes. Before a foaming reaction of the reactant occurs in the heat-conducting flame-retardant material, if the silicon dioxide accounts for 80% of the entire weight, the foaming reaction is completed after a foaming time of 6 seconds. And before a foaming reaction of the reactant occurs in the heat-conducting flame-retardant material, if the silicon dioxide accounts for 40% of the entire weight, the reaction is completed after a foaming time of 4 seconds. Before a foaming reaction of the reactant occurs, the heat-conducting flame-retardant material has application in the covering of battery cores, as well as in inner and outer covering materials for a battery core casing. A foaming reaction starts when the temperature reaches the reaction temperature of the reactant, and after the foaming reaction of the reactant occurs in the heat-conducting flame-retardant material, heat transfer to the interior and exterior of the battery core is blocked. After the foaming reaction of the reactant occurs in the heat-conducting flame-retardant material, flame retardancy thereof is UL94 rated up to V0˜5 VA, total thickness of the material is 600 μm and provides heat insulation at temperatures exceeding 800° C.

The present invention achieves the effects of heat conduction, explosion protection, and flame retardancy, and in particular has application in the covering of battery cores, whereby before a foaming reaction occurs, silicon dioxide material provides a heat conduction effect that prevents a battery core from overheating and exploding. After a foaming reaction occurs, the heat-conducting flame-retardant material can block heat transmission from the battery core and, thus, prevent extended combustion. The components and foaming technology characteristics of the present invention distinguish it from the prior art; moreover, its originality, advancement, and practical effectiveness are unmistakable.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a schematic cross-sectional view of a heat-conducting flame-retardant material filled between a battery core and a first metal packaging material according to the present invention.

FIG. 2 is a schematic cross-sectional view of the heat-conducting flame-retardant material filled between a first metal packaging material and a second metal packaging material according to the present invention.

### DETAILED DESCRIPTION OF THE PREFERRED EMBODIMENTS

The following description uses specific concrete examples to describe the embodiment modes of the present invention. Persons skilled in the related art can easily deduce other advantages and effects of the present invention from the content disclosed in the specification. The present invention can also use other different concrete embodiments to clarify its performance and applications. Each detail described in the specification can also be based on a different perspective and application, enabling various types of modifications and alterations to be carried out without deviating from the spirit of the present invention.

The present invention provides a heat-conducting flame-retardant material, wherein the heat-conducting flame-retardant material is a liquid state, colloidal state, or a semisolid state, and comprises: silicon dioxide, which accounts for 10-85% of the entire weight; a reactant, which has crosslinking properties and foaming reactivity, and is mixed with the silicon dioxide; and a catalyst, which is a temperature active or photoactive catalyst. The catalyst is mixed with the reactant to trigger a foaming reaction of the reactant. Before a foaming reaction of the reactant occurs, the heat-conducting flame-retardant material has heat conductivity, and is provided with flame retardant characteristics after a foaming reaction of the reactant occurs.

The average particle diameter of the silicon dioxide is 5 nm-10 μm, and the reactant starts a foaming reaction in an ambient temperature greater than 130° C. In an ambient temperature greater than 160° C., the reactant starts a foaming reaction that is completed in 30 seconds to 5 minutes. Before a foaming reaction of the reactant occurs in the heat-conducting flame-retardant material, if the silicon dioxide accounts for 80% of the entire weight, the foaming reaction is completed after a foaming time of 6 seconds. Before a foaming reaction of the reactant occurs in the heat-conducting flame-retardant material, if the silicon dioxide accounts for 40% of the entire weight, then the foaming reaction is completed after a foaming time of 4 seconds.

Before a foaming reaction of the reactant occurs in the heat-conducting flame-retardant material, the material can be used for coating battery cores, as well as for inner and outer covering materials for a battery core casing. When the temperature reaches the reaction temperature for the reactant to start a foaming reaction in the heat-conducting flame-retardant material, the foaming reaction causing blocking of heat transfer to the interior and exterior of the battery core. And after the foaming reaction of the reactant occurs in the heat-conducting flame-retardant material, flame retardancy is UL94 rated up to V0˜5 VA. After the foaming reaction of the reactant occurs in the heat-conducting flame-retardant material, total thickness thereof is 600 μm and provides heat insulation at temperatures exceeding 800° C. The method used to test the heat insulation temperature involved heating one side of a thin slice of the heat-conducting flame-retardant material with an overall thickness of 600 μm, and testing whether the temperature rose on the other side of the thin slice with a thermometer.

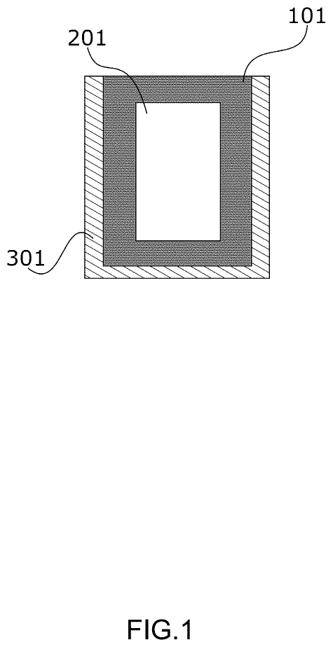

In order to enable the review committee to further understand practical applications of the present invention, examples of use in thermal conductivity and explosion-protection of battery cores can be seen in FIG. 1, which shows a schematic cross-sectional view of a heat-conducting flame-retardant material filled between a battery core and a first metal packaging material according to the present invention, wherein a heat-conducting flame-retardant material 101 of the present invention is filled between a battery core 201 and a first metal packaging material 301. The first metal packaging material 301 is an aluminum shell, aluminum foil, or a stainless steel shell, and the heat-conducting flame-retardant material 101 completely covers the battery core 201. When the battery core 201 generates heat during normal use, the heat-conducting flame-retardant material 101 in an unfoamed state can adequately dissipate heat energy, achieving a heat dissipation and cooling effect of the battery core 201. And when the battery core 201 is abnormally generating heat, the reactant in an ambient temperature greater than 130° C. starts a foaming reaction, which is completed within a foaming time of 30 seconds to 5 minutes, after which the heat-conducting flame-retardant material 101 can block outward heat transmission from the battery core 201 and prevent extended combustion. In other words, by merely covering internal smoldering of the single abnormal battery core 201 with the foamed heat-conducting flame-retardant material 101, after foaming of the heat-conducting flame-retardant material 101 has occurred, foamed air chambers in the material block heat transmission, causing the inability of the abnormal battery core 201 to continue heating up other battery cores or other electronic components.

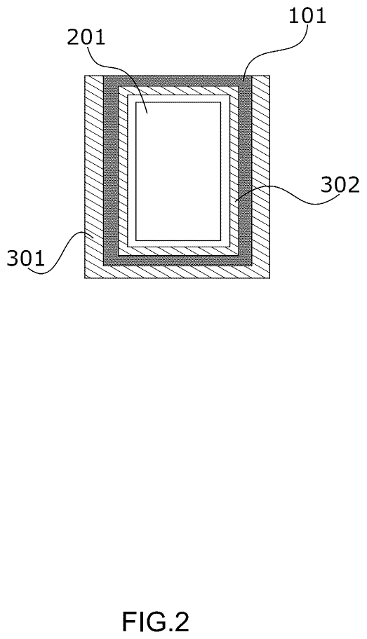

FIG. 2 is a schematic cross-sectional view of the heat-conducting flame-retardant material filled between a first metal packaging material and a second metal packaging material according to the present invention, which shows the heat-conducting flame-retardant material 101 filled between the first metal packaging material 301 and a second metal packaging material 302 according to present invention. The first metal packaging material 301 and the second metal packaging material 302 are aluminum shells, aluminum foils, or stainless steel shells, wherein the heat-conducting flame-retardant material 101 completely covers the second metal packaging material 302 surrounding the battery core 201. When the battery core 201 generates heat during normal use, the heat-conducting flame-retardant material 101 in an unfoamed state can adequately dissipate heat energy, achieving a heat dissipation and cooling effect of the battery core 201. And when the battery core 201 is abnormally generating heat, the reactant in an ambient temperature greater than 130° C. starts a foaming reaction, which is completed within a foaming time of 30 seconds to 5 minutes, after which the heat-conducting flame-retardant material 101 can block outward heat transmission from the battery core 201 and prevent extended combustion. In other words, by merely covering internal smoldering of the single abnormal battery core 201 with the foamed heat-conducting flame-retardant material 101, after foaming of the heat-conducting flame-retardant material 101 has occurred, foamed air chambers of the material block heat transmission, causing the inability of the abnormal battery core 201 to continue heating up other battery cores or other electronic components.

The present invention undoubtedly provides a heat-conducting flame-retardant material that enables providing heat conduction, explosion protection, and flame retardancy, which in particular has applications in the covering of battery cores. The components and foaming technology characteristics of the present invention distinguish it from the prior art; moreover, its originality, advancement, and practical effectiveness are unmistakable, which enable effective improvements on the shortcomings of the prior art.

In conclusion, regarding the specific structures of the embodiments disclosed in the present invention, the silicon dioxide material in the unfoamed heat-conducting flame-retardant material provides a heat conduction effect, and also enables producing a foaming reaction to prevent a battery core from overheating and exploding by blocking heat transmission from a battery core and preventing extended combustion. In terms of the overall components and foaming mechanism of the present invention, it provides both heat conduction and flame retardant effects, which have not been seen in like products; moreover, the contents of this specification have not been publicly disclosed prior to this application, clearly complying with the essential elements as required for a new patent. Accordingly, a patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A heat-conducting flame-retardant material, wherein the heat-conducting flame-retardant material is a liquid state, colloidal state, or a semisolid state, comprising:
silicon dioxide, which accounts for 10-85% of the entire weight;
a reactant, which has crosslinking properties and foaming reactivity, and is mixed with the silicon dioxide; and
a catalyst; which is a temperature active or photoactive catalyst, and when mixed with the reactant triggers a foaming reaction of the reactant;
before a foaming reaction of the reactant occurs, the heat-conducting flame-retardant material has heat conductivity, and is provided with flame retardant characteristics after a foaming reaction of the reactant occurs.

2. The heat-conducting flame-retardant material according to claim 1, wherein the average particle diameter of the silicon dioxide is 5 nm˜10 μm.

3. The heat-conducting flame-retardant material according to claim 1, wherein the reactant starts a foaming reaction in an ambient temperature greater than 130° C.

4. The heat-conducting flame-retardant material according to claim 1, wherein in an ambient temperature greater than 160° C., the reactant starts a foaming reaction that is completed in 30 seconds to 5 minutes.

5. The heat-conducting flame-retardant material according to claim 1, wherein before a foaming reaction of the reactant occurs in the heat-conducting flame-retardant material, the silicon dioxide accounts for 80% of the entire weight, and the foaming reaction is completed after a foaming time of 6 seconds.

6. The heat-conducting flame-retardant material according to claim 1, wherein before a foaming reaction of the reactant occurs in the heat-conducting flame-retardant material, the silicon dioxide accounts for 40% of the entire weight, and the foaming reaction is completed after a foaming time of 4 seconds.

7. The heat-conducting flame-retardant material according to claim 1, wherein before a foaming reaction of the reactant occurs, the heat-conducting flame-retardant material has application in the covering of battery cores, as well as in inner and outer covering materials for a battery core casing.

8. The heat-conducting flame-retardant material according to claim 1, wherein before a foaming reaction of the reactant occurs, the heat-conducting flame-retardant material has application in the covering of battery cores, as well as in inner and outer covering materials for a battery core casing; a foaming reaction starts when the temperature reaches the reaction temperature of the reactant, and after the foaming reaction of the reactant occurs in the heat-conducting flame-retardant material, heat transfer to an interior and exterior of the battery core is blocked.

9. The heat-conducting flame-retardant material according to claim 1, wherein after the foaming reaction of the reactant occurs in the heat-conducting flame-retardant material, flame retardancy thereof is UL94 rated up to V0˜5 VA.

10. The heat-conducting flame-retardant material according to claim 1, wherein after a foaming reaction of the reactant occurs in the heat-conducting flame-retardant material, total thickness thereof is 600 μm and provides heat insulation at temperatures exceeding 800° C.
